(19) United States
(12) Patent Application Publication
(10) Pub. No.: US 2022/0001469 A1
(43) Pub. Date: Jan. 6, 2022

(54) Cutter Having Customizable Ideal Mechanical Advantage at Each Point in the Cutting Stroke

(71) Applicant: Arevo, Inc., Milpitas, CA (US)

(72) Inventor: Steven George Manuel, San Mateo, CA (US)

(73) Assignee: Arevo, Inc., Milpitas, CA (US)

(21) Appl. No.: 16/918,996

(22) Filed: Jul. 1, 2020

(51) Int. Cl. B23D 17/04; B23D 17/08; B23D 29/00; B26B 13/06; B26B 13/28; B26B 15/00

(52) U.S. Cl. CPC B23D 17/04; B23D 17/08; B26B 15/00; B26B 13/06; B26B 13/28; B23D 29/00

(57) ABSTRACT

A powered shearing mechanism or cutter is disclosed that comprises an asynchronous double class 1 lever and a linear actuator that uses two ganged wheels to pry the effort portion of both levers open and close the jaws. The wheels move linearly—with the distance between them kept constant—and roll along—and exert force against—parts of the levers called “bearing surfaces.” The bearing surfaces are non-planar and reflectively symmetric and their profile is customized to provide any desired ideal mechanical advantage for the cutter. In accordance with the illustrative embodiment, the profile of the bearing surfaces is a circular arc, which provides a bearing surface which is easy to precisely fabricate and that provides a fairly constant ideal mechanical advantage at each point as the cutter's blades cut through the material.

### FIELD OF THE INVENTION

The present invention relates to a mechanism in general, and, more particularly, to a powered cutter that is based on a double class 1 lever.

### BACKGROUND OF THE INVENTION

A class 1 lever comprises one lever that has two portions—an effort portion and a load portion—and a fulcrum that is located between the effort portion and the load portion. A double class 1 lever comprises two levers—each with an effort portion and a load portion—and a single fulcrum that is located between the effort portion and the load portion of each lever. Many hand tools in the prior art are based on a double class 1 lever.

For example, many scissors, lineman's pliers, and diagonal cutters are based on double class 1 levers, and they are operated by squeezing together the handles (the effort portions of the levers), which has the effect of closing the jaws or blades (the load portions of the levers). Conversely, pulling apart the handles has the effect of opening the jaws or blades. For these mechanisms, closing the handles causes the jaws or blades to close, and opening the handles causes the jaws or blades to open. For the purposes of this specification, these double class 1 levers are called “synchronous double class 1 levers.”

In contrast, many piston-ring pliers, post hole diggers, and medical specula are based on double class 1 levers, but they are operated differently. In particular, they are operated by opening the handles (the effort portion of the levers), which has the effect of closing the jaws or blades (the load portion of the levers). Conversely, squeezing together the handles has the effect of opening the jaws or blades. For these mechanisms, opening the handles causes the jaws or blades to close, and closing the handles causes the jaws or blades to open. For the purposes of this specification, these double class 1 levers are called “asynchronous double class 1 levers.”

Despite the vast number of tools in the prior art, the need exists for a cutter that avoids some of the costs and disadvantages associated with cutters in the prior art.

### SUMMARY OF THE INVENTION

Some embodiments of the present invention are cutters that avoid some of the costs and disadvantage of cutters in the prior art.

The illustrative embodiment of the present invention is specifically designed to cut fiber-reinforced thermoplastic filament, but it will be clear to those skilled in the art, after reading this disclosure, that it and alternative embodiments of the present invention can be used to cut a wide variety of items (e.g., wire, pipes, cables, etc.).

The illustrative embodiment comprises an asynchronous double class 1 lever. The load portion of both levers compose the jaws of the cutter, and the load portion of each lever comprises a carbide cutting blade.

The effort portion of both levers are opened by a ganged pair of pneumatic cylinders and closed by a pair of tension springs. When the pneumatic cylinders are extended, they pry open the effort portions of both levers, which closes the jaws and cuts the filament. When the pneumatic cylinders are retracted, the tension springs close the effort portions of both levers and open the jaws.

In accordance with the illustrative embodiment, the width of the filament is approximately 1 mm, but its lateral location can vary by several millimeters. If the jaws were designed to open only one or two millimeters, the filament might not be reliably captured by the open jaws. Therefore, the jaws are designed to open wide (≈10 mm).

This creates another problem. The power provided by the pneumatic cylinders is constant throughout extension but the jaws only cut during a small portion (≈10%) of the distance that they close. Therefore, without more, about 90% of the energy from the pneumatic cylinders would be used to close the jaws without cutting the filament and only about 10% of the energy would be used for closing the jaws while cutting. This is disadvantageous. Instead, it would be preferable if little of the energy from the pneumatic cylinders was used to close the jaws without cutting the filament and more of the energy was used for closing the jaws while cutting. This is, in fact, what the illustrative embodiment accomplishes.

This illustrative embodiment accomplishes this by varying the ideal mechanical advantage of the pneumatic cylinder/asynchronous double class 1 lever mechanism throughout the 10 mm cutting stroke. During extension, the pneumatic cylinders push two ganged wheels that pry the effort portion of the levers open. As each wheel moves, it rolls along—and exerts force against—an area on the effort portion of a lever called the “bearing surface.” The bearing surface on each lever is reflectively symmetric to the bearing surface on the other lever. The shape and location of the bearing surface on each lever is deliberately to tailor the ideal mechanical advantage of the pneumatic cylinder/asynchronous double class 1 lever mechanism throughout the 10 mm cutting stroke, as shown in FIG. 7. The result is that the ideal mechanical advantage of the illustrative embodiment is low when the jaws are open between 10 mm and about 3 mm and very high when the jaws are open between about 3 mm and 0 mm.

It will be clear to those skilled in the art, after reading this disclosure, how to make and use alternative embodiments of the present invention in which the profile of the bearing surface is any curve (e.g., monotonic, non-monotonic, parabolic, elliptical, linear, tangential, cotangential, etc.) to provide any ideal mechanical advantage at each point as the cutter's blades cut through the material. For example, some illustrative embodiments might be made and used for cutting cladded material that initially has a high mechanical advantage when cutting through the cladding but then has a lower mechanical advantage when cutting through the interior material.

The illustrative embodiment is a cutter that comprises: a fulcrum; a first lever attached to the fulcrum, wherein the first lever comprises an effort portion of the first lever, a load portion of the first lever, and a first bearing surface on the effort portion of the first lever, and wherein the fulcrum is between the effort portion of the first lever and the load portion of the first lever to form a first class 1 lever; a second lever attached to about the fulcrum, wherein the second lever comprises an effort portion of the second lever, a load portion of the second lever, and a second bearing surface on the effort portion of the second lever, and wherein the fulcrum is between the effort portion of the second lever and the load portion of the second lever to form a second class 1 lever; a first wheel; a second wheel; and an actuator capable of: (i) moving the first wheel in a linear direction and against the first bearing surface, and (ii) moving the second wheel in the linear direction against the second bearing surface to move the load portion of the first lever towards the load portion of the second lever.

### BRIEF DESCRIPTION OF THE DRAWINGS

FIG. 1a depicts an orthographic front view of cutter 100 with its jaws fully open.

FIG. 1b depicts an orthographic side view of cutter 100 in with its jaws fully open.

FIG. 2 depicts an orthographic front view of cutter 100 with its jaws partially closed.

FIG. 3 depicts an orthographic front view of cutter 100 with its jaws fully closed.

FIG. 4 depicts an orthographic front view of left cutter arm 112-L in which left bearing surface 110-L is depicted with a dashed line. Left bearing surface 110-L is a non-planar surface whose profile is a circular arc with a radius of 150 mm.

FIG. 5 depicts an orthographic front view of right cutter arm 112-R in which right bearing surface 110-R is depicted with a dashed line.

FIG. 6 depicts the profile of left bearing surface 110-L over the full range of motion of roller wedge 108, which equals the stroke of left pneumatic cylinder 101-L and right pneumatic cylinder 101-R and is 45 mm.

FIG. 7 depicts the ideal mechanical advantage of cutter 100 as a function of how wide its jaws are open.

FIG. 8 depicts a first alternative profile of a left bearing surface over the full range of motion of roller wedge 108, which profile (when paired with a reflectively symmetric right bearing surface) provides an entirely different ideal mechanical advantage curve than shown in FIG. 7.

FIG. 9 depicts a second alternative profile of a left bearing surface over the full range of motion of roller wedge 108, which profile (when paired with a reflectively symmetric right bearing surface) provides an entirely different ideal mechanical advantage curve than shown in FIG. 7 or 8.

FIG. 10 depicts a third alternative profile of a left bearing surface over the full range of motion of roller wedge 108, which profile (when paired with a reflectively symmetric right bearing surface) provides an entirely different ideal mechanical advantage curve than shown in FIG. 7, 8, or 9.

FIG. 11 depicts a fourth alternative profile of a left bearing surface over the full range of motion of roller wedge 108, which profile (when paired with a reflectively symmetric right bearing surface) provides an entirely different ideal mechanical advantage curve than shown in FIG. 7, 8, 9, or 10.

### DEFINITIONS

Asynchronous Double Class 1 Lever—for the purposes of this specification, an “asynchronous double class 1 lever” is defined as a double class 1 lever in which closing the effort portions of the levers causes the load portions of the levers to open and opening the effort portions of the levers causes the load portions of the levers to close.

Class 1 Lever—For the purposes of this specification, a “class 1 lever” is defined as a lever comprising an effort portion, a load portion, and a fulcrum that is between the effort portion and the load portion.

Effort Portion and Load Portion of a Class 1 Lever—for the purposes of this specification, the fulcrum of a class 1 lever is between the “effort portion” of the lever and the load portion of the lever.

Synchronous Double Class 1 Lever—for the purposes of this specification, a “synchronous double class 1 lever” is defined as a double class 1 lever in which closing the effort portions of the levers causes the load portions of the levers to close and opening the effort portions of the levers causes the load portions of the levers to open.

### DETAILED DESCRIPTION

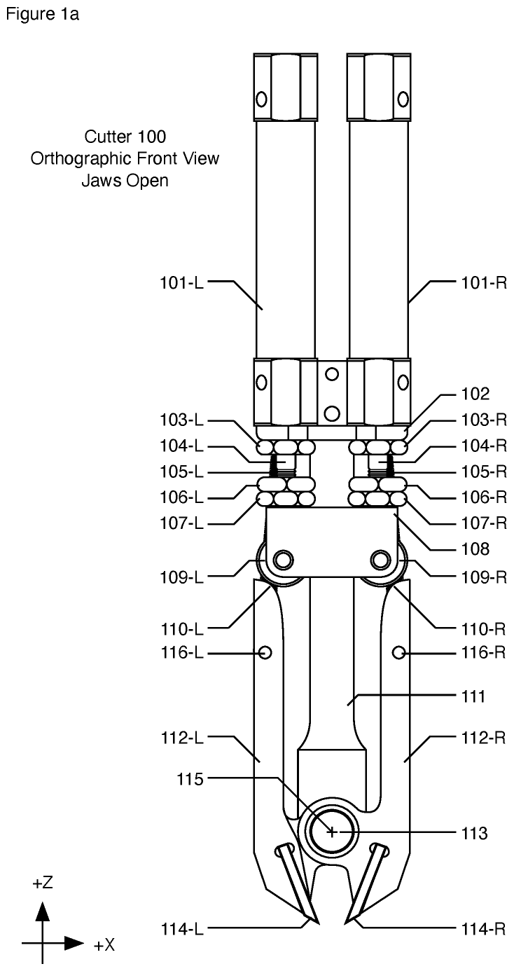

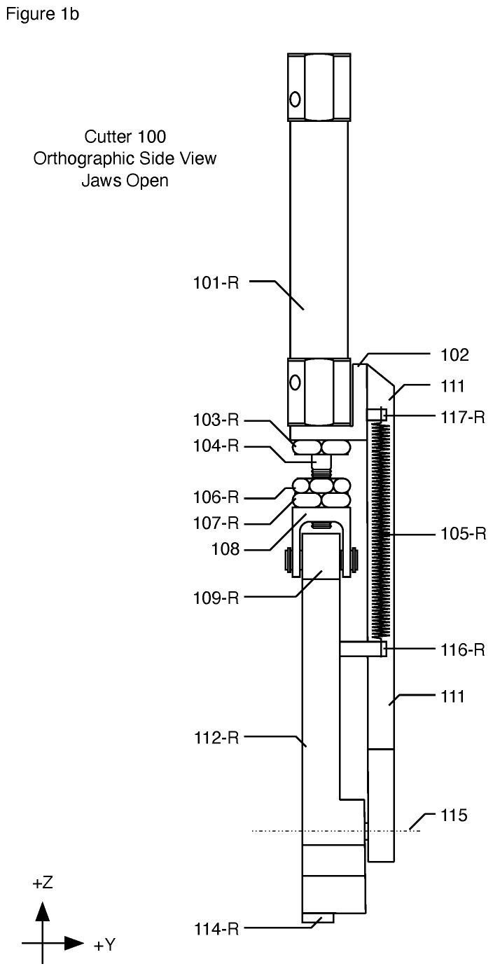

FIGS. 1a, 1b, 2, and 3 depict orthographic views of cutter 100 in accordance with illustrative embodiment of the present invention. FIGS. 1a, 1b, 2, and 3 are not drawn to scale; hidden lines are not depicted, and certain ancillary features are omitted from the drawings to facilitate the reader's understanding of the illustrative embodiment in particular and the inventive concepts in general.

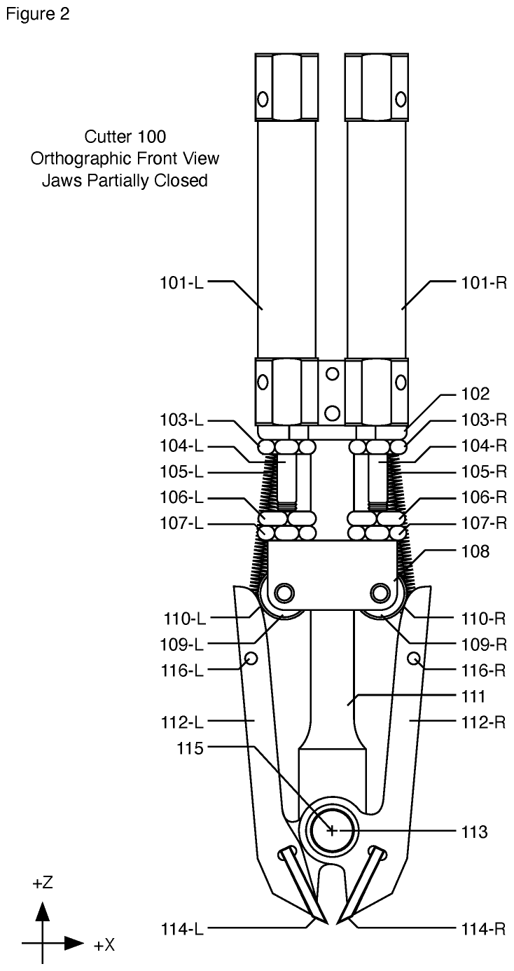

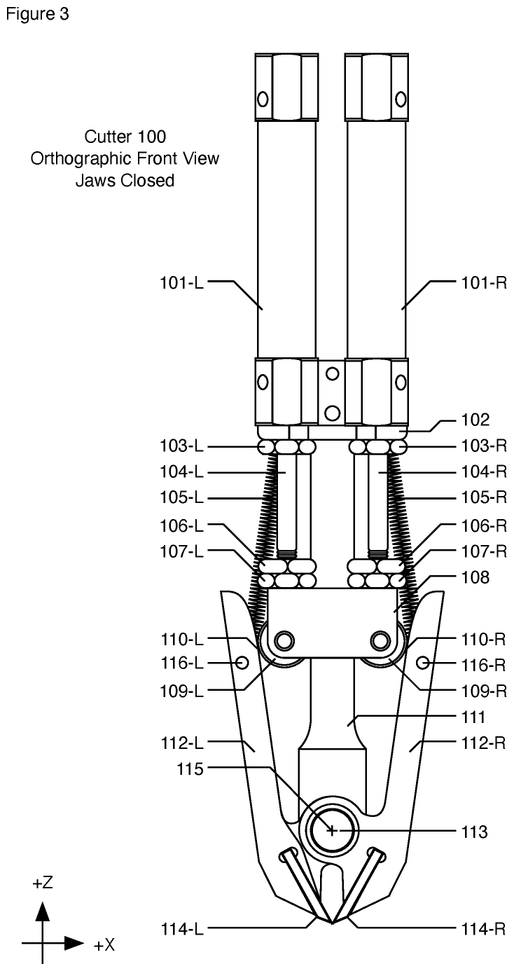

FIG. 1a depicts an orthographic front view of cutter 100 with its jaws fully open. FIG. 1b depicts an orthographic side view of cutter 100 in with its jaws fully open. FIG. 2 depicts an orthographic front view of cutter 100 with its jaws partially closed, and FIG. 3 depicts an orthographic front view of cutter 100 with its jaws fully closed.

Cutter 100 comprises left pneumatic cylinder 101-L, right pneumatic cylinder 101-R, cylinder bracket 102, left mounting nut 103-L, right mounting nut 103-R, left piston rod 104-L, right piston rod 104-R, left tension spring 105-L, right tension spring 105-R, hex nut 106-L, hex nut 106-R, hex nut 107-L, hex nut 107-R, roller wedge 108, left wheel 109-L, right wheel 109-R, left bearing surface 110-L, right bearing surface 110-R, frame 111, left cutter arm 112-L, right cutter arm 112-R, axle 113, left blade 114-L, right blade 114-R, axis of rotation 115, spring anchor 116-L, spring anchor 116-R, spring anchor 117-L (hidden in FIGS. 1a, 1b, 2, and 3), and spring anchor 117-R, interrelated as shown.

Left pneumatic cylinder 101-L and right pneumatic cylinder 101-R are identical pneumatically-powered linear actuators. For example, and without limitation, left pneumatic cylinder 101-L and right pneumatic cylinder 101-R are each 16 mm bore double-acting pneumatic cylinders with a 45 mm stroke. For example and without limitation, left pneumatic cylinder 101-L and right pneumatic cylinder 101-R are SMC Pneumatics CJ2 Round Body Cylinder part number CDJ2B16-45ARZ-A.

In accordance with the illustrative embodiment, left pneumatic cylinder 101-L and right pneumatic cylinder 101-R are simultaneously extended and retracted. In accordance with the illustrative embodiment, both left pneumatic cylinder 101-L and right pneumatic cylinder 101-R are simultaneously extended and retracted by presenting them with compressed air from one standard 5/2 pneumatic valve (not shown). It will be clear to those skilled in the art, after reading this disclosure, how to make and use alternative embodiments of the present invention in which multiple linear actuators are simultaneously extended and retracted.

In order to effect extension, left pneumatic cylinder 101-L and right pneumatic cylinder 101-R are presented with compressed air at 482.6 kPa (≈70 psi) at their respective extension air ports. The force of left pneumatic cylinder 101-L and right pneumatic cylinder 101-R during extension is resisted by the sum of:
(i) the load force of the object being cut, plus
(ii) the restorative force of left tension spring 105-L and right tension spring 105-R, plus
(iii) friction from the rotation of left cutter arm 112-L and right cutter arm 112-R around axle 113, plus
(iv) friction from the rotation of left wheel 109-L and right wheel 109-R around their respective axles.
   In practice, forces (ii), (iii), and (iv) are negligible compared to force (i), but forces (ii), (iii), and (iv) affect the actual mechanical advantage and mechanical efficiency of cutter 100.

In order to effect retraction, left pneumatic cylinder 101-L and right pneumatic cylinder 101-R are presented with compressed air at ═482.6 kPa (≈70 psi) at their respective retraction air ports. The force of left pneumatic cylinder 101-L and right pneumatic cylinder 101-R during retraction is assisted by the difference of:
(i) the restorative force of left tension spring 105-L and right tension spring 105-R, minus
(ii) friction from the rotation of left cutter arm 112-L and right cutter arm 112-R around axle 113.
   In practice, forces (i) and (ii) are negligible compared to the retraction force of left pneumatic cylinder 101-L and right pneumatic cylinder 101-R.

The source of compressed air, the 5/2 pneumatic valve, the valve actuator, pneumatic hoses, and hose fittings that deliver air to and vent air from left pneumatic cylinder 101-L and right pneumatic cylinder 101-R are omitted from the drawings for clarity. It will be clear to those skilled in the art how to present compressed air to left pneumatic cylinder 101-L and right pneumatic cylinder 101-R for both extension and retraction.

The illustrative embodiment comprises pneumatic cylinders as linear actuators but it will be clear to those skilled in the art, after reading this disclosure, how to make and use alternative embodiments of the present invention that use any linear actuator with comparable stroke and force.

The illustrative embodiment comprises two pneumatic cylinders, but it will be clear to those skilled in the art, after reading this disclosure, how to make and use alternative embodiments of the present invention that use any number of pneumatic cylinders (e.g., one pneumatic cylinder, three pneumatic cylinders, four pneumatic cylinders, etc.). In any case, it will be clear to those skilled in the art how to make and use left pneumatic cylinder 101-L and right pneumatic cylinder 101-R.

Cylinder bracket 102 is a stainless-steel member that is rigidly affixed to frame 111. Left pneumatic cylinder 101-L and right pneumatic cylinder 101-R are rigidly affixed to cylinder bracket 102 in such a manner that left piston rod 104-L and right piston rod 104-R are constrained to move linearly along lines that are parallel to the Z-axis. The nose of left pneumatic cylinder 101-L is threaded and is screwed into a first threaded thru-hole in cylinder bracket 102 and is locked in place with left mounting nut 103-L. Similarly, the nose of right pneumatic cylinder 101-R is threaded and is screwed into a second threaded thru-hole in cylinder bracket 102 and is locked in place with right mounting nut 103-R. Spring anchor 117-L (hidden in FIGS. 1a, 1b, 2, and 3) and spring anchor 117-R (shown in FIG. 1b) are steadfastly affixed to cylinder bracket 102. It will be clear to those skilled in the art, after reading this disclosure, how to make and use cylinder bracket 102.

Left mounting nut 103-L and right mounting nut 103-R are identical stainless-steel hex nuts that screw on the threaded nose of left pneumatic cylinder 101-L and right pneumatic cylinder 101-R, respectively, to steadfastly affix them to cylinder bracket 102. It will be clear to those skilled in the art how to make and use left mounting nut 103-L and right mounting nut 103-R.

Left piston rod 104-L and right piston rod 104-R are identical stainless-steel shafts with threaded ends that extend through left mounting nut 103-L and right mounting nut 103-R, respectively, into threaded thru holes in roller wedge 108. In accordance with the illustrative embodiment, left piston rod 104-L and right piston rod 104-R are ganged by roller wedge 108. It will be clear to those skilled in the art how to make and use left piston rod 104-L and right piston rod 104-R.

Left tension spring 105-L is a tension coil spring that imparts tension between spring anchor 117-L on cylinder bracket 102 and spring anchor 116-L on left cutter arm 112-L. Right tension spring 105-R is identical to left tension spring 105-L. Right tension spring 105-R imparts tension between spring anchor 117-R on cylinder bracket 102 and spring anchor 116-R on right cutter arm 112-R. The purpose of left tension spring 105-L and right tension spring 105-R is to open the jaws of cutter 100 when left piston rod 104-L and right piston rod 104-R are retracted. Left tension spring 105-L and right tension spring 105-R are, for example and without limitation, available from Misumi as UltraSpring Tension Coil Spring part number DE567. It will be clear to those skilled in the art how to make and use left tension spring 105-L and right tension spring 105-R.

Hex nut 106-L, hex nut 106-R, hex nut 107-L, and hex nut 107-R are identical stainless-steal hex nuts that steadfastly affix left piston rod 104-L and right piston rod 104-R to roller wedge 108. It will be clear to those skilled in the art how to make and use hex nut 106-L, hex nut 106-R, hex nut 107-L, hex nut 107-R.

Roller wedge 108 is a stainless-steel member to which left piston rod 104-L and right piston rod 104-R are steadfastly affixed and to which left wheel 109-L and right wheel 109-R are rotatably affixed. Roller wedge 108 ensures that the distance between left wheel 109-L and right wheel 109-R is constant during extension and retraction. It will be clear to those skilled in the art, after reading this disclosure, how to make and use roller wedge 108.

Left wheel 109-L is a stainless-steel wheel. During extension, roller wedge 108 moves linearly in the −Z direction, which moves left wheel 109-L linearly in the −Z direction which rolls left wheel 109-L against left bearing surface 110-L on left cutter arm 112-L. Left wheel 109-L re-directs a portion of the translational force in the −Z direction into a radial force against the effort portion of left cutter arm 112-L. The direction of the force is normal to the surface of left wheel 109-L at the location where left wheel 109-L and left bearing surface 110-L make contact.

Right wheel 109-R is identical to left wheel 109-L. During extension, roller wedge 108 moves linearly in the −Z direction, which moves right wheel 109-R linearly in the −Z direction which rolls right wheel 109-R against right bearing surface 110-R on right cutter arm 112-R. Right wheel 109-R re-directs a portion of the translational force in the −Z direction into a radial force against the effort portion of right cutter arm 112-R. The direction of the force is normal to the surface of right wheel 109-R at the location where right wheel 109-R and right bearing surface 110-R make contact.

The overall effect of moving roller wedge 108 in the −Z direction is to pry the effort portions of left cutter arm 112-L and right cutter arm 112-R apart, which pushes the jaws (i.e., the load portion of left cutter arm 112-L and the load portion of right cutter arm 112-R) together. It will be clear to those skilled in the art, after reading this disclosure, how to make and use left wheel 109-L and right wheel 109-R.

Left bearing surface 110-L is a non-planar surface on left cutter arm 112-L that contacts left wheel 109-L. Left bearing surface 110-L is coated, in well-known fashion, to protect against fatigue from sub-surface Hertzian stresses caused by left wheel 109-L as it rolls along left bearing surface 110-L. In accordance with the illustrative embodiment, the profile of left bearing surface 110-L is weakly monotonic and a circular arc with a radius of 150 mm. The curvature of left bearing surface 110-L is a factor in determining the mechanical advantage of cutter 100. Left bearing surface 110-L is described in detail below and in the accompanying figures.

Right bearing surface 110-R is a non-planar surface on right cutter arm 112-R that contacts right wheel 109-R. Right bearing surface 110-R is coated identically to left bearing surface 110-L also to protect against fatigue from sub-surface Hertzian stresses caused by right wheel 109-R as it rolls along right bearing surface 110-R. In accordance with the illustrative embodiment, the curvature of right bearing surface 110-R is reflectively symmetric to the curvature of left bearing surface 110-L (i.e., it is weakly monotonic a circular arc with a radius of 150 mm) and is also a factor in determining the mechanical advantage of cutter 100. Right bearing surface 110-R is described in detail below and in the accompanying figures.

Frame 111 is a stainless-steel member to which cylinder bracket 102 and axle 113 are affixed. The purpose of frame 111 is to maintain the relative spatial position of left pneumatic cylinder 101-L, right pneumatic cylinder 101-R, cylinder bracket 102, left mounting nut 103-L, right mounting nut 103-R, hex nut 106-L, hex nut 106-R, hex nut 107-L, hex nut 107-R, and axle 113 and to ensure that left cutter arm 112-L and right cutter arm 112-R rotate around axis of rotation 115. It will be clear to those skilled in the art, after reading this disclosure, how to make and use frame 111.

Left cutter arm 112-L is a stainless-steel lever that is rotatably affixed to axle 113 and that holds left blade 114-L. Spring anchor 116-L is steadfastly affixed to left cutter arm 112-L. Left cutter arm 112-L is a class 1 lever with axle 113 as the fulcrum. Left cutter arm 112-L comprises two portions: (i) an effort portion, and (ii) a load portion. The effort portion of left cutter arm 112-L comprises left bearing surface 110-L and receives the effort force from left wheel 109-L. The load portion of left cutter arm 112-L comprises left blade 114-L (i.e., one jaw of cutter 100) and receives the load force from the object being cut.

Right cutter arm 112-R is a stainless-steel lever that is rotatably affixed to axle 113 and that holds right blade 114-R. Spring anchor 116-R is steadfastly affixed to right cutter arm 112-R. Right cutter arm 112-R is a class 1 lever with axle 113 as the fulcrum. Right cutter arm 112-R comprises two portions: (i) an effort portion, and (ii) a load portion. The effort portion of right cutter arm 112-R comprises right bearing surface 110-R and receives the effort force from right wheel 109-R. The load portion of right cutter arm 112-R comprises right blade 114-R (i.e., one jaw of cutter 100) and receives the load force from the object being cut.

Together, left cutter arm 112-L, right cutter arm 112-R, and axle 113 compose an asynchronous double class 1 lever. It will be clear to those skilled in the art, however, after reading this disclosure, how to make and use alternative embodiments of the present invention that comprises a synchronous double class 1 lever.

Axle 113 is a stainless-steel cylinder that enables left cutter arm 112-L and right cutter arm 112-R to rotate freely around axis of rotation 115. Axle 113 is the fulcrum for left cutter arm 112-L and right cutter arm 112-R. It will be clear to those skilled in the art how to make and use axle 113.

Left blade 114-L and right blade 114-R are each identical carbide blades that form the cutting jaws of cutter 100. It will be clear to those skilled in the art how to make and use left blade 114-L and right blade 114-R.

Spring anchor 116-L and spring anchor 116-R are threaded stainless-steel rods that screw into threaded thru holes in left cutter arm 112-L and right cutter arm 112-R, respectively, and provide anchor points for left tension spring 105-L and right tension spring 105-R, respectively. It will be clear to those skilled in the art how to make and use spring anchor 116-L and spring anchor 116-R.

Spring anchor 117-L and spring anchor 117-R are threaded stainless-steel rods that screw into threaded thru holes in cylinder bracket 102, and provide anchor points for left tension spring 105-L and right tension spring 105-R, respectively. It will be clear to those skilled in the art how to make and use spring anchor 117-L and spring anchor 117-R.

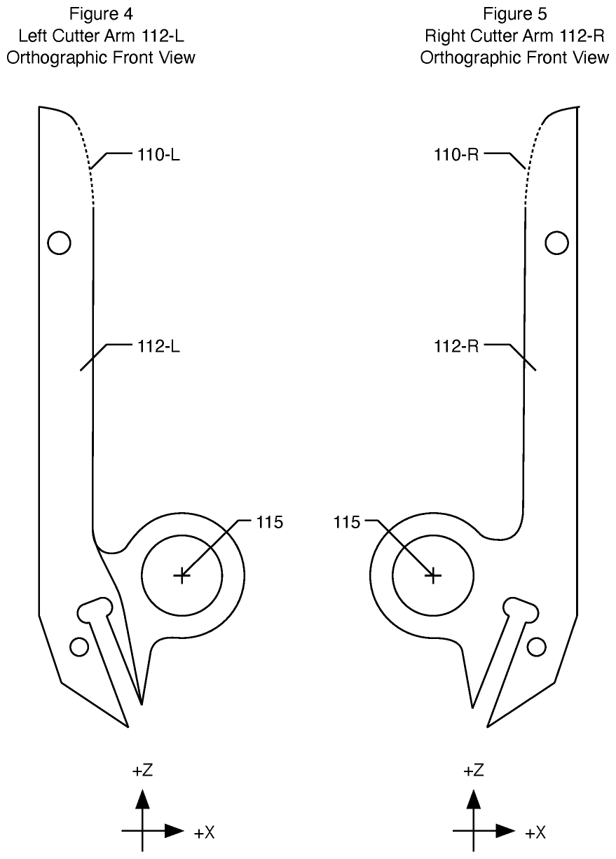

FIG. 4 depicts an orthographic front view of left cutter arm 112-L in which left bearing surface 110-L is depicted with a dashed line. Left bearing surface 110-L is a non-planar surface whose profile is a circular arc with a radius of 150 mm. FIG. 5 depicts an orthographic front view of right cutter arm 112-R in which right bearing surface 110-R is depicted with a dashed line. Right bearing surface 110-R is a non-planar surface whose profile is a circular arc with a radius of 150 mm. Left bearing surface 110-L and right bearing surface 110-R are reflectively symmetric.

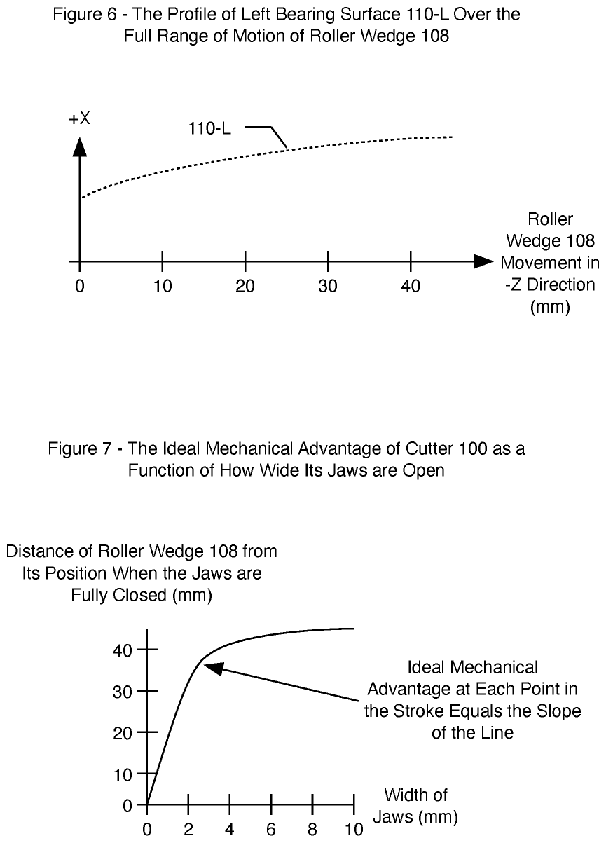

FIG. 6 depicts the profile of left bearing surface 110-L as a function of the full range of motion of roller wedge 108, which equals the stroke of left pneumatic cylinder 101-L and right pneumatic cylinder 101-R and is 45 mm. FIG. 7 depicts the ideal mechanical advantage of cutter 100 as a function of how wide its jaws are open. It can be seen in FIG. 7 that the ideal mechanical advantage of cutter 100 is low when the jaws are open between 10 mm and about 3 mm and very high when the jaws are open between about 3 mm and 0 mm.

The inventor of the present invention appreciated that the ideal mechanical advantage of cutter 100 is tailored by customizing the curvature of the profile of the left bearing surface 110-L and right bearing surface 110-R and that the ideal mechanical advantage of alternative embodiments of the present invention can be tailored by customizing the curvature of their bearing surfaces.

It will be clear to those skilled in the art, after reading this disclosure, how to determine the ideal mechanical advantage over the full range of motion of the roller wedge for any given curvature of the profile of the left and right bearing surfaces, and conversely, it will be clear to those skilled in the art, after reading this disclosure, how to determine the curvature of the profile of the left and right bearing surfaces for any desired ideal mechanical advantage over the full range of motion of the roller wedge.

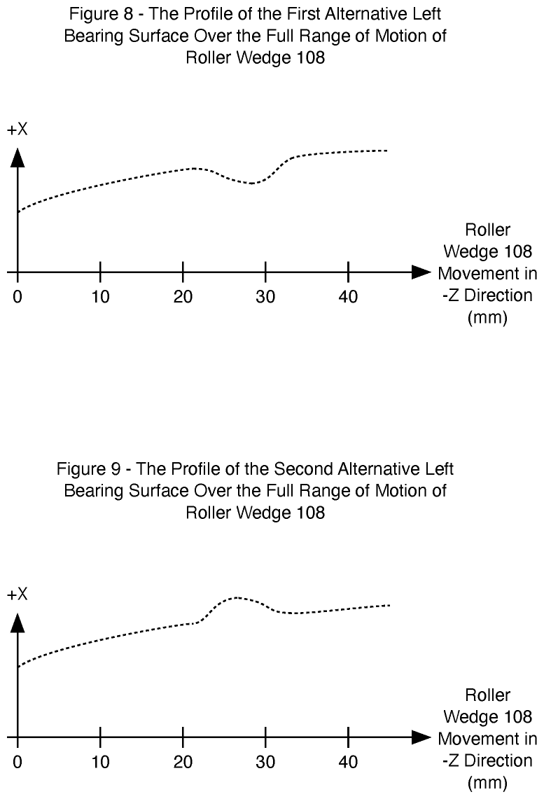

FIG. 8 depicts a first alternative profile of a left bearing surface over the full range of motion of roller wedge 108, which profile (when paired with a reflectively symmetric right bearing surface) provides an entirely different ideal mechanical advantage curve than shown in FIG. 7. The profile depicted in FIG. 8 is non-monotonic; it comprises a local minima, and it corresponds to a non-planar bearing surface. It will be clear to those skilled in the art how to determine the ideal mechanical advantage curve for the profile in FIG. 8.

FIG. 9 depicts a second alternative profile of a left bearing surface over the full range of motion of roller wedge 108, which profile (when paired with a reflectively symmetric right bearing surface) provides an entirely different ideal mechanical advantage curve than shown in FIG. 7 or 8. The profile depicted in FIG. 9 is non-monotonic; it comprises a local maxima, and it corresponds to a non-planar bearing surface. It will be clear to those skilled in the art how to determine the ideal mechanical advantage curve for the profile in FIG. 9.

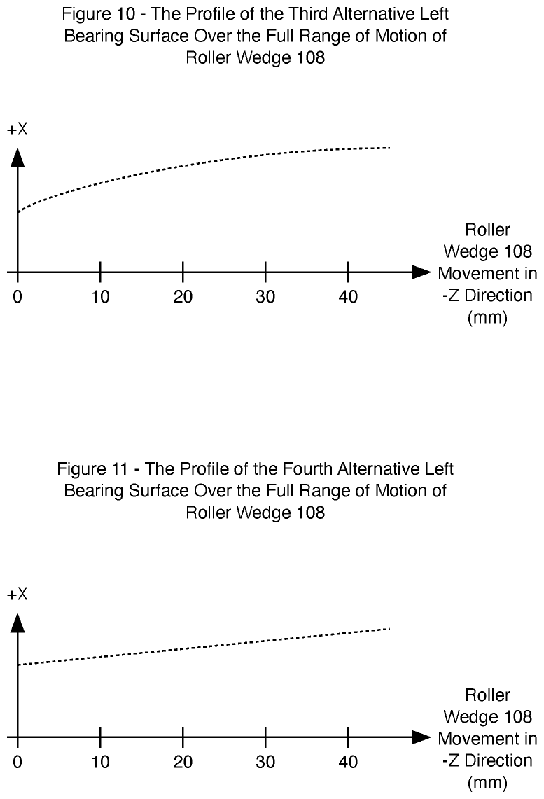

FIG. 10 depicts a third alternative profile of a left bearing surface over the full range of motion of roller wedge 108, which profile (when paired with a reflectively symmetric right bearing surface) provides an entirely different ideal mechanical advantage curve than shown in FIG. 7, 8, or 9. The profile depicted in FIG. 10 is monotonic and it corresponds to a non-planar bearing surface. It will be clear to those skilled in the art how to determine the ideal mechanical advantage curve for the profile in FIG. 10.

FIG. 11 depicts a fourth alternative profile of a left bearing surface over the full range of motion of roller wedge 108, which profile (when paired with a reflectively symmetric right bearing surface) provides an entirely different ideal mechanical advantage curve than shown in FIG. 7, 8, 9, or 10. The profile depicted in FIG. 11 is linear and monotonic and it corresponds to a planar bearing surface. It will be clear to those skilled in the art how to determine the ideal mechanical advantage curve for the profile in FIG. 11.

What is claimed is:

1. A cutter comprising:
a fulcrum;
a first lever attached to the fulcrum, wherein the first lever comprises an effort portion of the first lever, a load portion of the first lever, and a first bearing surface on the effort portion of the first lever, and wherein the fulcrum is between the effort portion of the first lever and the load portion of the first lever to form a first class 1 lever;
a second lever attached to about the fulcrum, wherein the second lever comprises an effort portion of the second lever, a load portion of the second lever, and a second bearing surface on the effort portion of the second lever, and wherein the fulcrum is between the effort portion of the second lever and the load portion of the second lever to form a second class 1 lever;
a first wheel;
a second wheel; and
an actuator capable of:
(i) moving the first wheel in a linear direction and against the first bearing surface, and
(ii) moving the second wheel in the linear direction against the second bearing surface
to move the load portion of the first lever towards the load portion of the second lever.

2. The cutter of claim 1 wherein the first lever, the second lever, and the fulcrum compose an asynchronous double class 1 lever.

3. The cutter of claim 1 wherein the first bearing surface and the second bearing surface are reflectively symmetric.

4. The cutter of claim 1 wherein the ideal mechanical advantage is not constant as the actuator moves the first wheel in the linear direction.

5. The cutter of claim 1 wherein the ideal mechanical advantage of the first lever is constant as the actuator moves the first wheel in the linear direction.

6. The cutter of claim 1 wherein the distance between the first wheel and the second wheel is constant as the actuator moves the first wheel and the second wheel in the linear direction.

7. The cutter of claim 1 wherein the first bearing surface is non-planar and has a circular arc profile.

8. The cutter of claim 1 wherein the first bearing surface is non-planar and has a parabolic profile.

9. The cutter of claim 1 wherein the first bearing surface is non-planar and has a non-monotonic profile with a local minima.

10. The cutter of claim 1 wherein the first bearing surface is non-planar and has a non-monotonic profile with a local maxima.

11. A cutter comprising:
a fulcrum;
a first lever attached to the fulcrum, wherein the first lever comprises an effort portion of the first lever, a load portion of the first lever, and a first bearing surface on the effort portion of the first lever, and wherein the fulcrum is between the effort portion of the first lever and the load portion of the first lever to form a first class 1 lever;
a second lever attached to about the fulcrum, wherein the second lever comprises an effort portion of the second lever, a load portion of the second lever, and a second bearing surface on the effort portion of the second lever, and wherein the fulcrum is between the effort portion of the second lever and the load portion of the second lever to form a second class 1 lever;
a first wheel;
a second wheel; and
an actuator capable of:
(i) rolling the first wheel along the length of the first bearing surface, and
(ii) rolling the second wheel along the length of the second bearing surface to move the load portion of the first lever towards the load portion of the second lever.

12. The cutter of claim 11 wherein the first lever, the second lever, and the fulcrum compose an asynchronous double class 1 lever.

13. The cutter of claim 11 wherein the first bearing surface and the second bearing surface are reflectively symmetric.

14. The cutter of claim 11 wherein the ideal mechanical advantage is not constant as the actuator moves the first wheel in the linear direction.

15. The cutter of claim 11 wherein the ideal mechanical advantage of the first lever is constant as the actuator moves the first wheel in the linear direction.

16. The cutter of claim 11 wherein the distance between the first wheel and the second wheel is constant as the actuator moves the first wheel and the second wheel in the linear direction.

17. The cutter of claim 11 wherein the first bearing surface is non-planar and has a circular arc profile.

18. The cutter of claim 11 wherein the first bearing surface is non-planar and has a parabolic profile.

19. The cutter of claim 11 wherein the first bearing surface is non-planar and has a non-monotonic profile with a local minima.

20. The cutter of claim 11 wherein the first bearing surface is non-planar and has a non-monotonic profile with a local maxima.
